(19) United States
(12) Patent Application Publication
(10) Pub. No.: US 2005/0257886 A1
(43) Pub. Date: Nov. 24, 2005

(54) Process for producing electrical apparatus

(76) Inventors: Takayuki Matsushima, Tochigi (JP); Masao Saito, Tochigi (JP)

Correspondence Address: OSHA LIANG L.L.P., 1221 MCKINNEY STREET, SUITE 2800, HOUSTON, TX, 77010, US

(21) Appl. No.: 10/505,342

(22) PCT Filed: Feb. 14, 2003
(86) PCT No.: PCT/JP03/01591

§ 371 Date: Jun. 24, 2005

(30) Foreign Application Priority Data
Feb. 21, 2002 (JP) 2002-044232

(51) Int. Cl. B32B 31/26

(52) U.S. Cl. 156/307.3; 156/310; 156/307.7

(57) ABSTRACT

Disclosed is a method for producing an electrical device by electrically and mechanically interconnecting two objects for bonding. When an adhesive layer (25) provided to an LCD (11) and a layer of a second curing agent (28) provided to a TCP (15) are brought into tight contact with each other and thrust in this state to each other under heating, a first curing agent in the adhesive layer (25) and a second curing agent forming the layer of the second curing agent react with each other so that the thermosetting resin in the adhesive layer is polymerized to bond the LCD (11) and the TCP (15) together to produce an electrical device. In case a metal chelate or a metal alcoholate and a silane coupling agent are used as the first and second curing agents, respectively, the silane coupling agent and the metal chelate react with each other to yield cations and, by these cations, the thermosetting resin undergoes cationic polymerization. The adhesive may be cured to bond the LCD (11) and the TCP (15) together in a shorter time at a lower temperature than in case the conventional adhesive is used.

### TECHNICAL FIELD

This invention relates to a method for producing an electrical device by bonding first and second objects for bonding each carrying an electrode.

This application claims priority based on the Japanese Patent Application 2002-044232, filed in Japan on Feb. 21, 2002, the entirety of which is incorporated by reference herein.

### BACKGROUND ART

Conventionally, a thermally curing adhesive, containing an epoxy resin, as a thermosetting resin, and which is cured on thermal polymerization of the epoxy resin, is used as an adhesive used for bonding objects for bonding, such as a semiconductor or a substrate, to prepare an electrical device.

For accelerating the reaction of thermal polymerization of the epoxy resin, a curing agent is routinely used in an adhesive. As this sort of the curing agent, a curing agent, functioning as a polymerization catalyst for the epoxy resin, such as an imidazole compound, or a curing agent, which per se undergoes an addition reaction with an epoxy resin to form a polymer, such as a mercaptan compound or an amine compound, is widely used.

In case the imidazole compound is used as a curing agent, the adhesive may be cured in a short time. However, in this case, the adhesive needs to be heated to an elevated temperature exceeding 180° C., such that the objects for bonding may be subjected to deformation, such as elongation or bend, due to heating.

In case the amine compound or the mercaptan compound is used as a curing agent, the adhesive may be cured at a lower temperature. However, in this case, the time needed for the adhesive to be cured is longer than with the imidazole compound, thus lowering the productivity. With the adhesive, cured at a lower temperature, the polymerization reaction proceeds even at an ambient temperature, and hence the adhesive is appreciably inferior in shell life. It has so far been difficult to obtain an adhesive cured at a lower temperature in a shorter time and which nevertheless has a long shell life.

### DISCLOSURE OF THE INVENTION

It is an object of the present invention to provide a method for producing an electrical device with which it is possible to resolve the problem inherent in the aforementioned conventional method.

It is another object of the present invention to provide a method for producing an electrical device easily promptly by bonding first and second objects for bonding using an adhesive having a long shell life and which may be cured at a lower temperature in a shorter time.

### DISCLOSURE OF THE INVENTION

For accomplishing the above objects, the present invention provides a method for producing an electrical device made up by a first object for bonding including a first electrode and a second object for bonding including a second electrode to be connected to the first electrode, by bonding the first object for bonding and the second object for bonding to each other. The method of the present invention comprises the steps of arranging an adhesive, containing a thermosetting resin and a first curing agent, at least on the second electrode, to form an adhesive layer, arranging a second curing agent, reacted with the first curing agent by heating to polymerize the thermosetting resin, at least on the second electrode, to form a layer of the second curing agent, positioning the first and second electrodes in register with each other, tightly contacting the adhesive on the first object for bonding with the second curing agent on the second object for bonding, and thrusting the first and second objects for bonding against each other for interconnecting the first and second electrodes and allowing the thermosetting resin to be polymerized by heating.

With the method for producing the electrical device according to the present invention, electrically conductive particles are added to the adhesive from the outset and the first and second electrodes are interconnected via the electrically conductive particles.

One of the first and second curing agents is mainly composed of a silane coupling agent and the other is mainly composed of one or both of a metal chelate and a metal alcoholate. The metal chelate forming the other curing agent is an aluminum chelate. As the metal alcoholate, an aluminum alcoholate is used.

The thermosetting resin, forming an adhesive, used in the manufacturing method of the present invention, is an epoxy resin.

If, with the method for producing the electrical device according to the present invention, the layer of the second curing layer on the second object for bonding is thrust against the adhesive layer of the first object for bonding, the first curing agent in the adhesive layer is commingled with the second curing agent forming the layer of the second curing layer. If, in a state the first and second curing agents are commingled with each other, the adhesive layer is heated, the first and second curing agents react with each other to allow polymerization of the thermosetting resin.

If, in case the adhesive is high in viscosity or the adhesive is in the form of a film, the second object for bonding is thrust as the adhesive is heated, the adhesive is softened by the heating, thus assuring facilitated intrusion of the second electrode and the second curing agent into the bulk of the adhesive, as well as facilitated diffusion of the second curing agent into the adhesive layer. The second curing agent may be diffused into the adhesive layer more readily by employing the second curing agent liquid at ambient temperature.

The reaction in which the silane coupling agent and the metal chelate are used as the first and second curing agents, respectively, and the epoxy resin is used as the thermosetting resin, is expressed by the following reaction formulas (1) to (4):

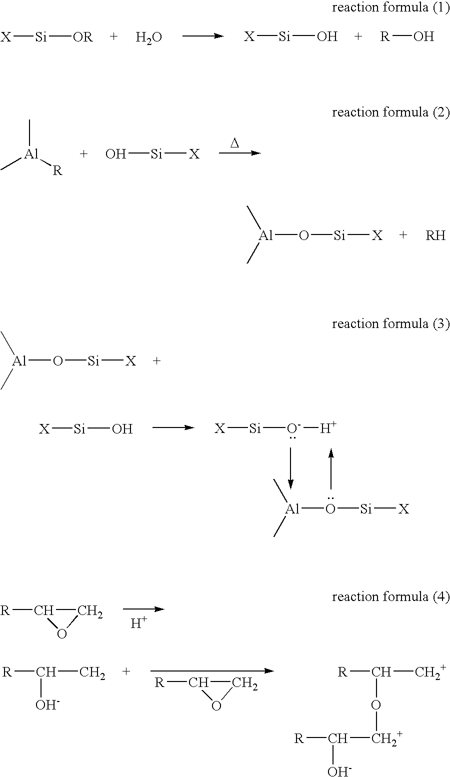

The silane coupling agent, indicated on the left side of the reaction formula (1), has an alkoxy group (RO) linked to silicon. If the silane coupling agent is contacted with water contained in atmosphere or in an adhesive, the alkoxy group is hydrolyzed to yield silanol (right side of the reaction formula (1)).

An aluminum chelate, as a metal chelate, is indicated on the left side of the reaction formula (2), by way of an example. If, as the second curing agent and the adhesive are mixed together, the adhesive is heated, the silanol, yielded on hydrolysis of the silane coupling agent, is reacted with the aluminum chelate, due to heating, so that silicon of the silanol is linked to aluminum through an oxygen atom (right side of the reaction formula (2)).

If another silanol is coordinated to the aluminum chelate in this state by an equilibrium reaction, a Bronsted acid point is produced, as indicated on the right side of the reaction formula (3), to yield an activated proton.

As indicated by the reaction formula (4), the epoxy ring, disposed at a terminal end of the epoxy resin, is opened by an activated proton and polymerized with an epoxy ring of another epoxy resin (cationic polymerization).

Since the reaction by the reaction formulas (2) and (3) proceeds at a temperature lower than the curing temperature of a conventional adhesive (180° C. or higher), the two-component adhesive according to the present invention is cured at a lower temperature in a shorter time than with a conventional adhesive.

Since the reaction of the cationic polymerization proceeds as a chain reaction, the adhesive layer in its entirety may be cured even in case the second curing agent is not evenly dispersed into the adhesive layer.

If, in case the silane coupling agent is used as the first and second curing agents, water is added to these first and second curing agents, the reaction of the reaction formula (1) may proceed in the curing agent, thus accelerating the reaction in curing the adhesive.

As a method for arranging the layer of the second curing agent, the layer of the second curing agent may readily be formed, from the perspective of the manufacturing process, by charging the second curing agent into a vessel, holding the second object for bonding by a holding mechanism, and by immersing the second object for bonding in the second curing agent in the vessel.

The method for forming the layer of the second curing agent is not limited to the above method. For example, there are such a method consisting in spraying the second curing agent to the area of the second object for bonding to be bonded to the first object for bonding, and such a method consisting in coating the second curing agent using e.g. a brush. With the use of these methods, the amount of consumption of the second curing agent may be smaller than with the method of immersing the object for bonding in the second curing agent.

In case the second curing agent, solid at room temperature, is used, it may be used as a coating solution, obtained by dispersing the agent in e.g. an organic solution, in which case the layer of the second curing layer may be formed more readily.

Other objects and advantages of the present invention will become more apparent from the following description especially when read in conjunction with the drawings.

### BRIEF DESCRIPTION OF THE DRAWINGS

FIG. 1 is a cross-sectional view showing a release film that makes up an adhesive film used in the method of the present invention.

FIG. 2 is a cross-sectional view showing an adhesive film composed of a release film and an adhesive layer formed thereon.

FIG. 3 is a cross-sectional view showing an LCD as an object for bonding,

FIG. 4 is a cross-sectional view showing the state in which the adhesive film has been arranged on the surface of the LCD and

FIG. 5 is a cross-sectional view showing the state in which the adhesive film arranged on the surface of the LCD has been peeled off.

FIG. 6 is a cross-sectional view showing a TCP as the other object for bonding, and

FIG. 7 is a cross-sectional view showing the state in which a layer of the second curing agent has been formed on the surface of the TCP.

FIG. 8 is a cross-sectional view showing the state in which the LCD and the TCP to be bonded together are positioned facing each other,

FIG. 9 is a cross-sectional view showing the state in which the LCD and the TCP are abutted to each other and

FIG. 10 is a cross-sectional view showing the state in which the LCD and the TCP have been bonded together to form an electrical device.

FIG. 11, showing another example of the method of the present invention, is a cross-sectional view showing the state in which an adhesive layer has been formed on an LCD surface carrying a first electrode thereon, and

FIG. 12 is a cross-sectional view showing the state in which the LCD and the TCP have been bonded together to form an electrical device.

### BEST MODE FOR CARRYING OUT THE INVENTION

Referring to the drawings, a method for producing an electrical device according to the present invention is explained in detail.

The method for producing an adhesive used in the method for producing the electrical device according to the present invention is explained.

For producing the adhesive, e.g. an epoxy resin, as a thermosetting resin, a silane coupling agent, as a first curing agent, and electrically conductive particles, are mixed and agitated together, to yield a paste-like adhesive. This adhesive has not been added by metal chelates nor by metal alcoholates and has been added solely by a silane coupling agent. Hence, there is produced no polymerization reaction of the epoxy resin, so that the adhesive is not cured.

The adhesive used in the method for producing the electrical device according to the present invention is coated in a preset amount on a release film, and handled in this state.

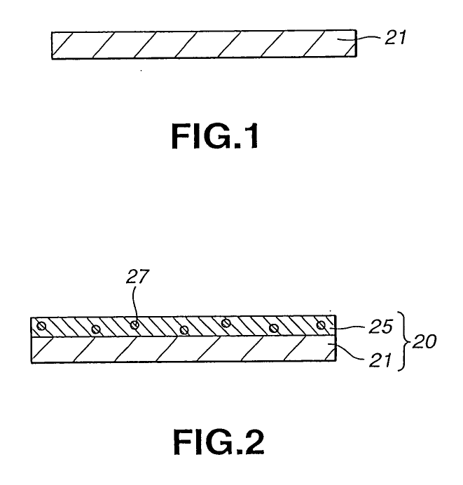

The adhesive prepared by the above-described process is coated in a preset amount on the surface of the release film 21 shown in FIG. 1, and subsequently dried. The adhesive material, coated on the surface of the release film 21 and subsequently dried, is formed as an adhesive layer 25 on the surface of the release film 21. In the bulk of the adhesive layer 25, there are dispersed electrically conductive particles 27 mixed into the adhesive of the adhesive layer 25.

The process for producing an electrical device 10, using an adhesive film 20, made up by the release film 21 and the adhesive layer 25, formed thereon, is now explained.

The electrical device 10, produced in accordance with the present method, is formed by bonding an LCD (liquid crystal display) 11, as a first object for bonding, to a TCP (tape carrier package) 15, as a second object for bonding.

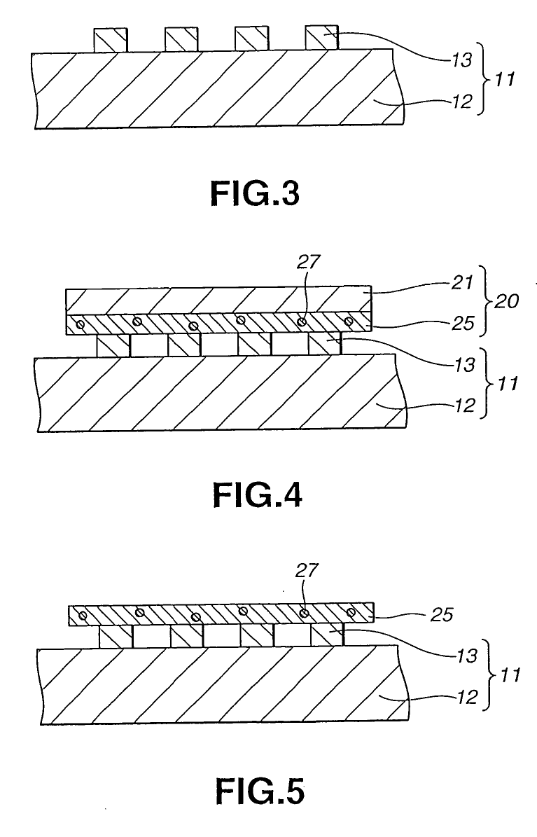

The LCD 11, as an object for bonding, forming an electrical device to be produced according to the method of the present invention, includes a glass substrate 12, and a plural number of first electrodes 13, formed on the surface of the glass substrate 12, as shown in FIG. 3. In an example shown in FIG. 4, four first electrodes 13 are shown.

The adhesive layer 25 on the release film 21 is thrust against the surface of the LCD 11, carrying the first electrode 13 of the LCD 11, and to which the TCP as later explained is to be connected, as shown in FIG. 4. Since the force of bonding between the release film 21 and the adhesive layer 25 is smaller than the force of bonding between the adhesive layer 25 and the first electrodes 13, solely the release film 21 may be peeled off, as the adhesive layer 25 is left on the LCD 11.

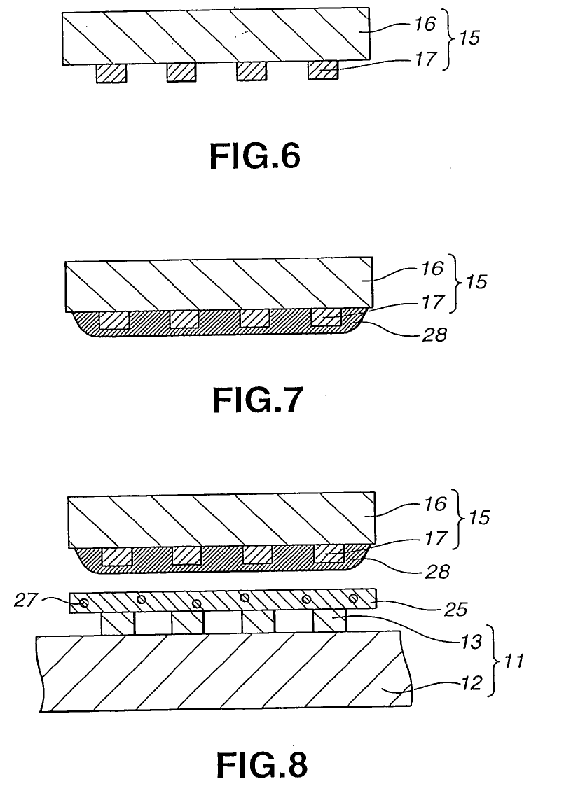

The TCP 15, bonded to the LCD 11, has a base film 16, on one surface of which there are formed a plural number of second electrodes 17, as shown in FIG. 6. In the example shown in FIG. 6, four second electrodes 17 are shown.

On the surface of the TCP 15, carrying the second electrodes 17, a second curing agent is applied to form a layer of a second curing agent 28 is formed, as shown in FIG. 7. At this time, the second electrodes 17 are covered up by the layer of the second curing agent 28.

Then, for bonding the TCP 15 to the LCD 11, the LCD and the TCP are arranged parallel to each other, with the surfaces of the LCD and the TCP, carrying the first electrodes 13 and the second electrodes 17, respectively, facing each other, as shown in FIG. 8. At this time, the LCD 11 and the TCP 15 are positioned with the plural first electrodes 13 and the plural second electrodes 17 face each other, as shown in FIG. 8.

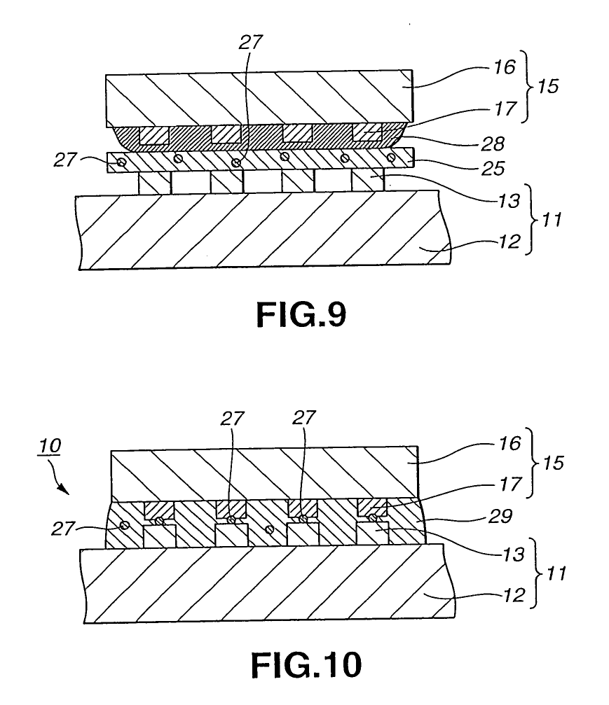

The layer of the second curing agent 28 on the TCP 15 is then thrust against the adhesive layer 25 on the LCD 11 and the surface of the layer of the second curing agent 28 is brought into tight contact with the surface of the adhesive layer 25, as shown in FIG. 9.

If, in the state shown in FIG. 9, the LCD 11 and the TCP 15 in their entirety are heated, as the TCP 15 is thrust against the LCD 11, the adhesive layer 25 is softened, such that the second electrodes 17 are intruded into the bulk of the adhesive layer 25. Since the softened adhesive layer 25 is fluid, the second curing agent making up the layer of the second curing agent 28 is diffused into the adhesive layer 25, when the layer of the second curing agent 28 is intruded into the adhesive layer 25, so that the second curing agent is commingled with the first curing agent in the adhesive layer. If the TCP 15 is further thrust towards the LCD 11, the second electrodes 17 are further intruded into the bulk of the adhesive layer 25, such that the electrically conductive particles 27 in the adhesive layer 25 are clinched between the second electrodes 17 and the first electrodes 13, as shown in FIG. 10. If the trusting under heating is further continued, the first curing agent and the second curing agent are reacted by heating to polymerize the epoxy resin to cure the adhesive layer 25 to bond the LCD 11 and the TCP 15 together, as the electrically conductive particles 27 are clinched between the second electrodes 17 and the first electrodes 13. The TCP 15 and the LCD 11, bonded together by a cured adhesive layer 29, electrically interconnect the first and second electrodes 13, 17 via electrically conductive particles 27, while also mechanically interconnecting the electrodes, to form the electrical device 10, as shown in FIG. 10.

The foregoing explanation refers to a case where the LCD 11 and the TCP 15 are bonded together using the adhesive film 20 comprised of the release film 21 and the adhesive layer 25 coated thereon. The present invention is, however, not limited to this case, such that, by way of an example, the paste-like adhesive may directly be applied to the surface of the LCD 11 carrying the first electrodes 13 to bond the TCP 15 to the LCD 11.

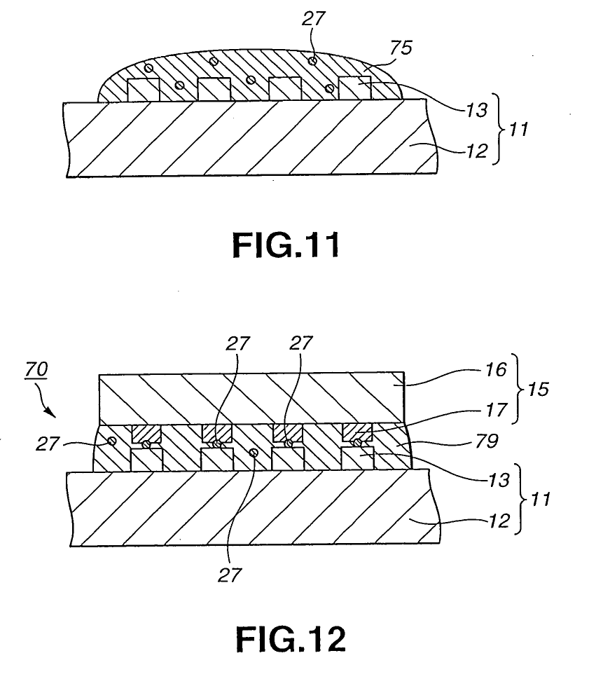

That is, in case the paste-like adhesive is directly used, a paste-like adhesive, containing the electrically conductive particles 27 dispersed therein, is coated on the surface of the LCD 11, as one of the objects for bonding, carrying the first electrodes 13, as shown in FIG. 3, so as to overlie the first electrodes 13 to form an adhesive layer 75, as shown in FIG. 11.

The TCP 15, as the other object for bonding, carrying the second electrodes 17, as shown in FIG. 6, is arranged facing the LCD 11. In this case, the LCD 11 and the TCP 15 are positioned so that the surfaces thereof carrying the first electrodes 13 and the second electrodes 17 face each other, with the first electrodes 13 and the second electrodes 17 facing each other. If the TCP 15 is abutted against the LCD 11 and, as in the above case of using the adhesive film 20, the TCP 15 is further thrust towards the LCD 11, as heating is continued, the second electrodes 17 are intruded into the bulk of the adhesive layer 75, such that the electrically conductive particles 27 in the adhesive layer 75 are clinched between the second electrodes 17 and the first electrodes 13. If the trusting under heating is further continued, the first curing agent and the second curing agent are reacted by the heating to polymerize the epoxy resin to cure the adhesive layer 25 to bond the LCD 11 and the TCP 15 together, as the electrically conductive particles 27 in the adhesive layer 25 are clinched between the second electrodes 17 and the first electrodes 13, as shown in FIG. 12. The TCP 15 and the LCD 11, bonded together by a cured adhesive layer 29, electrically interconnect the first and second electrodes 13, 17 via electrically conductive particles 27, while also mechanically interconnecting the electrodes, to form an electrical device 70, as shown in FIG. 12.

Several concrete Examples of the method for producing the electrical device according to the present invention are hereinafter explained.

### EXAMPLE 1

First, an Example 1 of the method for producing an electrical device according to the present invention is explained.

In the present Example 1, the LCD 11 and the TCP 15 are bonded together, using an adhesive, as now explained, to produce an electrical device.

A paste-like adhesive was prepared by mixing 5 parts by weight of an epoxy silane coupling agent (manufactured by SHIN-ETSU KAGAKU KOGYO KK under a trade name of ‘KBM-403’), as a first curing agent, 40 parts by weight of alicyclic epoxy resin celoxide (manufactured and sold by DICEL KAGAKU KOGYO KK under the trade name of ‘2021P’) as an epoxy resin, 60 parts by weight of bisphenol A epoxy resin as an epoxy resin (manufactured and sold by YUKA SHELL EPOXY KK under the trade name of ‘EP1009’) and10 parts by weight of electrically conductive particles. This adhesive was coated to a film thickness of 20 μm on the surface of the release film 21 to form the adhesive layer 25 to produce the adhesive film 20. The adhesive layer 25, formed on the adhesive film 20, is deposited on the surface of the LCD 11, carrying the first electrodes 13, as described above.

As the second curing agent, ethyl acetoacetate aluminum diisopropylate (manufactured by KAWAKEN FINECHEMICAL KK under the trade name of ‘ALCH’), as a metal chelate, was prepared. The second curing agent was coated on the surface of the TCP, carrying the second electrodes 17, to form a layer of the second curing agent 28.

The LCD 11, on which the adhesive layer 25, formed of the aforementioned adhesive, has been deposited, and the LCD 11, on which the layer of the curing agent 28, formed of the aforementioned second curing agent, has been deposited, were bonded together by the above-described process to produce the electrical device 10 of the Example 1.

As the TCP 15, forming the electrical device 10, such a one in which the second electrodes 17, each of a width of 25 μm, were formed on the surface of the base film 16, at an interval of 25 μm, was used. As the LCD 11, such a one carrying ITO (indium tin oxide) electrodes 13, each being of a sheet resistance of 10Ω per 1 cm² surface area, was used. In bonding the LCD 11 and the TCP 15 to each other, a thermo-compression head, not shown, maintained at 120° C., was thrust against the areas of the LCD 11 and the TCP 15, superposed one on the other, for ten seconds, under heating, in order to raise the temperature of the adhesive layer 25 to 120° C. The TCP and the LCD were bonded together in this manner to produce the electrical device 10.

### EXAMPLE 2

In the Example 1, the adhesive layer 25 was prepared in the same way as in Example 1, except using the metal chelate, used in Example 1, in place of the epoxy silane coupling agent, as the first curing agent.

Moreover, the epoxy silane coupling agent, used in Example 1, was provided as the second curing agent, in place of the metal chelate.

In this Example 2, the adhesive film 20 used was again an adhesive coated on the release film 21 to form the adhesive layer 25.

The LCD 11, carrying the adhesive layer 25, and the TCP 15, carrying the layer of the second curing agent 28, formed by the second curing agent, are bonded together through a process similar to the process of the above Example 1 to give the electrical device 10 of Example 2.

### EXAMPLE 3

In the Example 3, the following adhesive was used. For producing the adhesive, 50 parts by weight of a product (manufactured and sold by DICEL KAGAKU KOGYO KK under the trade name of celoxide ‘2021P’) as an epoxy resin, and 50 parts by weight of a product (manufactured and sold by YUKA SHELL EPOXY KK under the trade name of ‘EP100’) as an epoxy resin, were mixed together. The resulting mixture was stirred, as it was kept at 70° C., to form a solution of paste-like epoxy resin. To 100 parts by weight of this solution of paste-like epoxy resin, 5 parts by weight of the first curing agent (epoxy silane coupling agent) used in Example 1 and 10 parts by weight of the electrically conductive particles, used in Example 1, were added and mixed together to form a paste-like adhesive. The adhesive, thus prepared, is coated on the surface of the LCD 11 of Example 1, carrying the first electrodes 13, to form an adhesive layer 75.

On the other hand, the layer of the second curing agent 28 is formed, using the same second curing agent (metal chelate) as that used in Example 1, on the surface of the TCP 15, carrying the second electrodes 17, and which is to be bonded to the LCD 11 carrying the adhesive layer 75.

The LCD 11, carrying the adhesive layer 75, and the TCP 15, carrying the layer of the second curing agent 28, formed by the second curing agent, are bonded together through a process similar to the process of the above Example 1 to give the electrical device 70 of Example 3.

### EXAMPLE 4

In this Example 4, the electrical device 70 was prepared under the same conditions as in Example 3, except using the second curing agent (metal chelate), used in the above Example 3, as the first curing agent, and also except using the first curing agent (epoxy silane coupling agent) used in Example 3, as the second curing agent.

### COMPARATIVE EXAMPLE 1

A Comparative Example, for comparison with the electrical device, produced by the method of the present invention, was prepared. This Comparative Example is hereinafter explained.

This Comparative Example employs an adhesive film, obtained on coating an adhesive used in Example 1 in a film form on a release film. In forming the adhesive layer on the release film, used in the Comparative Example 1, 2 parts by weight of the second curing agent, used in Example 1, were added to and mixed with 115 parts by weight of the adhesive used in Example 1, to prepare an adhesive containing both the first and second curing agents, and this adhesive was coated on the release film used in Example 1 and dried in situ. In this manner, the adhesive film having the adhesive layer was prepared.

The LCD 11, carrying the adhesive layer, formed on the first adhesive film of the Comparative Example 1, and the TCP 15, prior to being coated with the second curing agent, were bonded together by the same process and conditions as those of the above Example 1 to produce the electrical device of the Comparative Example 1.

### COMPARATIVE EXAMPLE 2

The Comparative Example 2 is now explained. In this Comparative Example 2, 2 parts by weight of the second curing agent, used in Example 3 (metal chelate), were added to and mixed with the paste-like adhesive used in the above Example 3, to produce an adhesive containing both the first and second curing agents. In the Comparative Example 2, this adhesive was applied to the surface of the LCD 11 carrying the first electrodes 13 to form an adhesive layer. The LCD 11, carrying the adhesive layer, and the TCP 15, prior to being coated with the second curing agent, were bonded together by the same process and conditions as those of the above Example 1 to produce the electrical device of the Comparative Example 2.

The ‘peel-off strength test’, as now explained, was carried out for each of the electrical devices 10, 70 obtained by the above Examples 1 to 4 and by the above Comparative Examples 1 and 2.

[Peel-Off Strength Test]

Using a tensile tester, the TCP 15, bonded to the LCD 11 to form the electrical device, obtained by each of the above Examples 1 to 4 and the above Comparative Examples 1 and 2, was pulled in a direction of 90° relative to the surface of the LCD 11, at a rate of tension of 50 mm per min, and measurement was made of the peel-off strength when the TCP 15 is actually peeled off from the LCD 11. The measured results of the peel-off strength test of the Examples and Comparative Examples are shown in the following Table 1:

TABLE 1
Results of Peel-off Strength Test

| | | | | | Comp. | Comp. |
|---|---|---|---|---|---|---|
| | Ex. 1 | Ex. 2 | Ex. 3 | Ex. 4 | Ex. 1 | Ex. 2 |
| peel-off | 11.5 | 11.8 | 13.2 | 13.4 | 1.3 | 1.3 |
| strength (N/cm) | | | | | | |

It is seen from the results of Table 1 that, with the Examples 1 to 4 in which the first adhesive material having the first curing agent and the second adhesive material having the second curing agent are discretely coated to the TCP 15 and to the LCD 11, and the TCP and the LCD are subsequently bonded to each other, the peel-off strength is higher, thus testifying to the high bonding strength of the electrical device, prepared by the method of the present invention, despite the fact that the adhesive could be cured to bond the TCP and the LCD together under the condition of the lower temperature and shorter time (120° C. and 10 seconds) than conventionally.

On the other hand, with the Comparative Examples 1 and 2, in which the first and second curing agents are added to the same adhesive, the peel-off strength was intolerably low. This is presumably ascribable to the fact that the viscosity of the adhesive was gradually increased by the reaction of the first and second curing agents, as from the time of adhesive preparation, such that the adhesive lost its bonding properties before thrusting the TCP 15 and the LCD 11 to each other under heating.

The foregoing explanation refers to a case where the first electrodes 13 and the second electrodes 17 are interconnected electrically and mechanically through the electrically conductive particles 27. The present invention is, however, not limited to this case. For example, it is possible to prepare the first and second adhesive materials without addition of the electrically conductive particles into the adhesive material and to interconnect the first and second electrodes by directly abutting the second electrodes against the first electrodes during the thrusting under heating. In case the electrically conductive particles 27 are used, it is sufficient if the electrically conductive particles 27 are added to one of the first and second adhesive materials.

The metal chelates or alcoholates that may be used may include a variety of center atoms, such as atoms of zirconium, titanium or aluminum. Of these, aluminum chelates or aluminum alcoholates, having aluminum, exhibiting particularly high reactivity, as the center atoms, are preferred.

There is no limitation to the sort of the ligands of the aluminum chelate or to the sort of the alkoxyl groups of the aluminum alcoholates. For example, alkyl acetoacetate aluminum diisopropylate or aluminum monoacetyl acetonate bis(ethylacetoacetate), may be used as the aluminum chelate, in addition to ethyl acetoacetate aluminum diiropropylate used in the aforementioned Examples 1 and 2.

As the silane coupling agent, a compound shown by the following general formula (5): 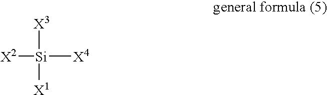
is preferably employed.

Of the substituents X¹ to X⁴ in the general formula (5), at least one substituent is an alkoxy group. At least one of the substituents X¹ to X⁴ other than the alkoxy group preferably includes an epoxy ring or a vinyl group. As the substituent having the epoxy ring, a glycidyl group is most preferred.

The foregoing explanation refers to a case where the epoxy resin is used as the thermosetting resin added to the adhesive. The present invention is, however, not limited to this case. Although a wide variety of resins, such as urea resin, melaminic resin, phenolic resin, vinylether resin or oxycetane resin, that allow for cationic polymerization, may be used, it is preferred to use epoxy resin from the perspective of the strength of the cured adhesive.

The adhesive may be added by e.g. thermoplastic resin, in addition to the thermosetting resin. As the thermoplastic resin, phenoxy resin, polyester resin, polyurethane resin, polyvinyl acetal, ethylene vinylacetate or rubbers, such as polybutadiene rubber, may be used. Additionally, the adhesive used in the present invention may be added by a variety of additives, such as ageing-proofing agents, fillers or colorants.

The foregoing explanation refers to a case where the LCD 11 and the TCP 15 are used as the first object for bonding and as the second object for bonding. The present invention is, however, not limited to this embodiment. Foe example, the TCP 15 and the LCD 11 may be used as the first object for bonding and as the second object for bonding, respectively, and the adhesive and the layer of the second curing agent may be arranged on the TCP 15 and on the LCD 11, respectively.

The first and second objects for bonding are not limited to the LCD 11 or TCP 15, such that the adhesive of the present invention may be used for interconnecting a wide variety of circuit substrates, such as semiconductor chip or flexible circuit board.

The present invention is not limited to the embodiments described with reference to the drawings and, as may be apparent to those skilled in the art, various changes, substitutions or equivalents may be envisaged without departing from the scope and the purport of the invention as defined in the appended claims.

### INDUSTRIAL APPLICABILITY

The adhesive used in the method for producing the electrical device according to the present invention may be cured at a lower temperature in a shorter time than was possible up to now because the epoxy resin undergoes cationic polymerization by the reaction between the silane coupling agent and the metal chelate. The second curing agent is isolated from the first curing agent or from the thermosetting resin, no polymerization reaction of the thermosetting resin occurs before actually bonding the objects for bonding, thus improving the shell life of the adhesive.

1. A method for producing an electrical device made up by a first object for bonding including a first electrode and a second object for bonding including a second electrode to be connected to said first electrode, by bonding said first object for bonding and said second object for bonding to each other, comprising the steps of
arranging an adhesive, containing a thermosetting resin and a first curing agent, at least on said second electrode, to form an adhesive layer;
arranging a second curing agent, reacted with said first curing agent by heating to polymerize said thermosetting resin, at least on said second electrode, to from a layer of the second curing agent;
positioning said first and second electrodes in register with each other;
tightly contacting said adhesive on said first object for bonding with said second curing agent on said second object for bonding; and
thrusting said first and second objects for bonding against each other for interconnecting said first and second electrodes and allowing said thermosetting resin to be polymerized by heating.

2. The method for producing an electrical device according to claim 1 wherein electrically conductive particles are added to said adhesive from the outset and wherein said first and second electrodes are interconnected via said electrically conductive particles.

3. The method for producing an electrical device according to claim 1 wherein one of said first and second curing agents is mainly composed of a silane coupling agent and the other is mainly composed of one or both of a metal chelate and a metal alcoholate.

4. The method for producing an electrical device according to claim 3 wherein said metal chelate is an aluminum chelate.

5. The method for producing an electrical device according to claim 3 wherein said metal alcoholate is an aluminum alcoholate.

6. The method for producing an electrical device according to claim 1 wherein said thermosetting resin is an epoxy resin.
